(19) United States
(12) Patent Application Publication
(10) Pub. No.: US 2012/0108224 A1
(43) Pub. Date: May 3, 2012

(54) USING QUALITY OF SERVICE TO CONTROL HARDWARE FOR LOW BATTERY SCENARIOS

(75) Inventors: Steven D. Cheng, San Diego, CA (US); Guangming Shi, San Diego, CA (US); Tom Chin, San Diego, CA (US)

(73) Assignee: QUALCOMM Incorporated, San Diego, CA (US)

(21) Appl. No.: 13/253,766

(22) Filed: Oct. 5, 2011

Related U.S. Application Data
(63) Continuation-in-part of application No. 12/351,802, filed on Jan. 9, 2009.

(51) Int. Cl. H04W 52/02

(52) U.S. Cl. 455/418

(57) ABSTRACT

Certain embodiments of the present disclosure relate to methods for reducing power consumption of a mobile device while maintaining QoS of communication links. If the available battery power is below a predefined threshold, then several power-saving techniques may be triggered that increase an air time of the mobile device by shutting down one or more modem hardware components.

### CROSS-REFERENCE TO RELATED APPLICATIONS

This application is a continuation-in-part of, and claims benefit from, U.S. patent application Ser. No. 12/351,802 entitled “Methods and Systems for Dynamic Service Flow Using Available Battery Power” filed Jan. 9, 2009 which is assigned to the assignee of this application and is fully incorporated herein by reference for all purposes.

### TECHNICAL FIELD

Certain embodiments of the present disclosure generally relate to wireless communication and, more particularly, to decreasing mobile station power consumption in certain scenarios.

### BACKGROUND

The current wireless communication protocols range from a 4^{th} generation (4G) such as Worldwide Interoperability for Microwave Access (WiMAX), to a 3^{rd} generation (3G) such as an Universal Mobile Telecommunications System (UMTS) and an Evolution-Data Optimized (EV-DO) standard, to a 2^{nd} generation (2G) such as a Code Division Multiple Access (CDMA) and a Global System for Mobile communications (GSM). All of these communication protocols consider a service flow feature and a Quality of Service (QoS) feature of every connection link between a mobile device and a base station, but these particular features are not integrated with any issues related to battery availability of the mobile device.

Unfortunately, if battery power at the mobile device becomes low, then the mobile device cannot guarantee that the service flow feature and the QoS feature can be correctly implemented.

### SUMMARY

Certain embodiments provide a method for wireless communications. The method generally includes monitoring available battery power at a mobile device, when the available battery power is below a threshold, determining a combination of hardware components to maintain one or more communication links between physical layer hardware and hardware used by a protocol stack while maintaining quality of service (QoS) requirements for the one or more communication links, and switching to the determined combination of hardware components.

Certain embodiments provide an apparatus for wireless communications. The apparatus generally includes means for monitoring available battery power at a mobile device, when the available battery power is below a threshold, means for determining a combination of hardware components to maintain one or more communication links between physical layer hardware and hardware used by a protocol stack while maintaining quality of service (QoS) requirements for the one or more communication links, and means for switching to the determined combination of hardware components.

Certain embodiments provide an apparatus for wireless communications. The apparatus generally includes at least one processor and a memory coupled to the at least one processor. The at least one processor is typically adapted to monitor available battery power at a mobile device, when the available battery power is below a threshold, determine a combination of hardware components to maintain one or more communication links between physical layer hardware and hardware used by a protocol stack while maintaining quality of service (QoS) requirements for the one or more communication links, and switch to the determined combination of hardware components.

Certain embodiments provide a computer-program product for wireless communications, comprising a computer readable medium having instructions stored thereon, the instructions being executable by one or more processors. The instructions generally include instructions for monitoring available battery power at a mobile device, when the available battery power is below a threshold, determining a combination of hardware components to maintain one or more communication links between physical layer hardware and hardware used by a protocol stack while maintaining quality of service (QoS) requirements for the one or more communication links, and switching to the determined combination of hardware components.

### BRIEF DESCRIPTION OF THE DRAWINGS

So that the manner in which the above-recited features of the present disclosure can be understood in detail, a more particular description, briefly summarized above, may be had by reference to embodiments, some of which are illustrated in the appended drawings. It is to be noted, however, that the appended drawings illustrate only certain typical embodiments of this disclosure and are therefore not to be considered limiting of its scope, for the description may admit to other equally effective embodiments.

FIG. 1 illustrates an example wireless communication system, in accordance with certain embodiments of the present disclosure.

FIG. 2 illustrates various components that may be utilized in a wireless device in accordance with certain embodiments of the present disclosure.

FIG. 3 illustrates an example transmitter and an example receiver that may be used within a wireless communication system in accordance with certain embodiments of the present disclosure.

FIG. 4 shows example operations for saving power consumption at a mobile device in accordance with certain embodiments of the present disclosure.

FIG. 4A illustrates example components capable of performing the operations illustrated in FIG. 4.

FIG. 5 illustrates a total average data rate step function with input parameter of battery power availability in accordance with certain embodiments of the present disclosure.

FIG. 6 illustrates power consumption at the mobile device versus a processor clock rate when the processor consumes a fixed Millions of Instructions per Second (MIPS) rate in accordance with certain embodiments of the present disclosure.

FIG. 7 illustrates the total average data rate at the mobile device as a function of its processor clock rate in accordance with certain embodiments of the present disclosure.

FIG. 8 illustrates modem hardware components in a mobile device in accordance with certain embodiments of the present disclosure.

FIGS. 9A-9D illustrate example configurations of active modem hardware components in accordance with certain embodiments of the present disclosure.

FIG. 10 illustrates example operations for reducing power consumption at a mobile device in accordance with certain embodiments of the present disclosure.

FIG. 10A illustrates example components capable of performing the operations illustrated in FIG. 10.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

### An Example Wireless Communication System

The techniques described herein may be used for various broadband wireless communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

One specific example of a communication system based on an orthogonal multiplexing scheme is a WiMAX system. WiMAX, which stands for the Worldwide Interoperability for Microwave Access, is a standards-based broadband wireless technology that provides high-throughput broadband connections over long distances. There are two main applications of WiMAX today: fixed WiMAX and mobile WiMAX. Fixed WiMAX applications are point-to-multipoint, enabling broadband access to homes and businesses, for example. Mobile WiMAX offers the full mobility of cellular networks at broadband speeds.

IEEE 802.16x is an emerging standard organization to define an air interface for fixed and mobile broadband wireless access (BWA) systems. IEEE 802.16x approved “IEEE P802.16d/D5-2004” in May 2004 for fixed BWA systems and published “IEEE P802.16e/D12 Oct. 2005” in October 2005 for mobile BWA systems. The latest revision of the IEEE 802.16-2004, “IEEE P802.16Rev2/D6 Jul. 2008,” a draft standard, now consolidates materials from IEEE 802.16e and corrigendum. The standards define four different physical layers (PHYs) and one medium access control (MAC) layer. The OFDM and OFDMA physical layer of the four physical layers are the most popular in the fixed and mobile BWA areas respectively.

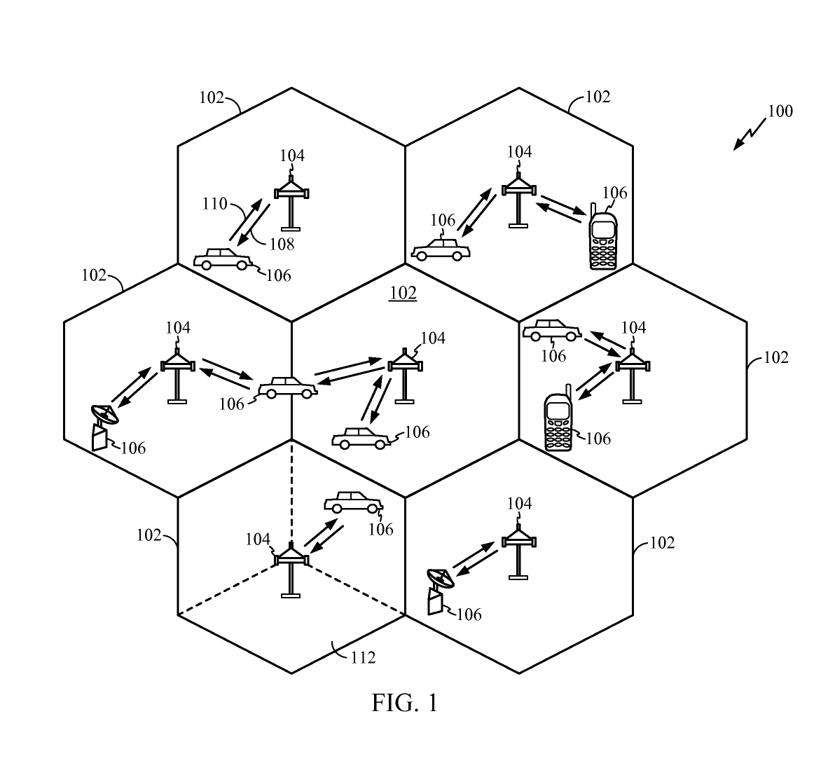

FIG. 1 illustrates an example of a wireless communication system 100 in which embodiments of the present disclosure may be employed. The wireless communication system 100 may be a broadband wireless communication system. The wireless communication system 100 may provide communication for a number of cells 102, each of which is serviced by a base station 104. A base station 104 may be a fixed station that communicates with user terminals 106. The base station 104 may alternatively be referred to as an access point, a Node B or some other terminology.

FIG. 1 depicts various user terminals 106 dispersed throughout the system 100. The user terminals 106 may be fixed (i.e., stationary) or mobile. The user terminals 106 may alternatively be referred to as remote stations, access terminals, terminals, subscriber units, mobile stations, stations, user equipment, etc. The user terminals 106 may be wireless devices, such as cellular phones, personal digital assistants (PDAs), handheld devices, wireless modems, laptop computers, personal computers, etc.

A variety of algorithms and methods may be used for transmissions in the wireless communication system 100 between the base stations 104 and the user terminals 106. For example, signals may be sent and received between the base stations 104 and the user terminals 106 in accordance with OFDM/OFDMA techniques. If this is the case, the wireless communication system 100 may be referred to as an OFDM/OFDMA system.

A communication link that facilitates transmission from a base station 104 to a user terminal 106 may be referred to as a downlink (DL) 108, and a communication link that facilitates transmission from a user terminal 106 to a base station 104 may be referred to as an uplink (UL) 110. Alternatively, a downlink 108 may be referred to as a forward link or a forward channel, and an uplink 110 may be referred to as a reverse link or a reverse channel.

A cell 102 may be divided into multiple sectors 112. A sector 112 is a physical coverage area within a cell 102. Base stations 104 within a wireless communication system 100 may utilize antennas that concentrate the flow of power within a particular sector 112 of the cell 102. Such antennas may be referred to as directional antennas.

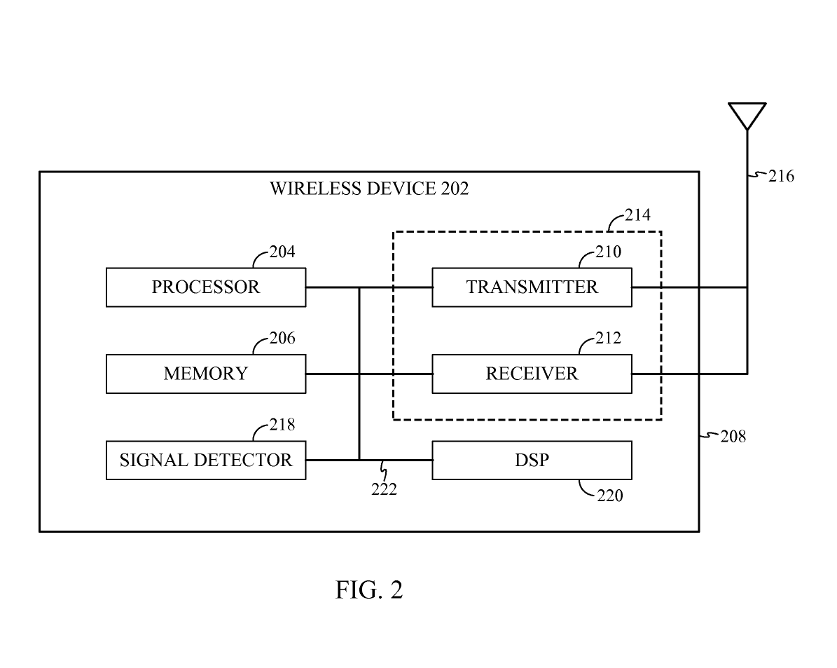

FIG. 2 illustrates various components that may be utilized in a wireless device 202 that may be employed within the wireless communication system 100. The wireless device 202 is an example of a device that may be configured to implement the various methods described herein. The wireless device 202 may be a base station 104 or a user terminal 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals.

The various components of the wireless device 202 may be coupled together by a bus system 222, which may include a power bus, a control signal bus, and a status signal bus in addition to a data bus.

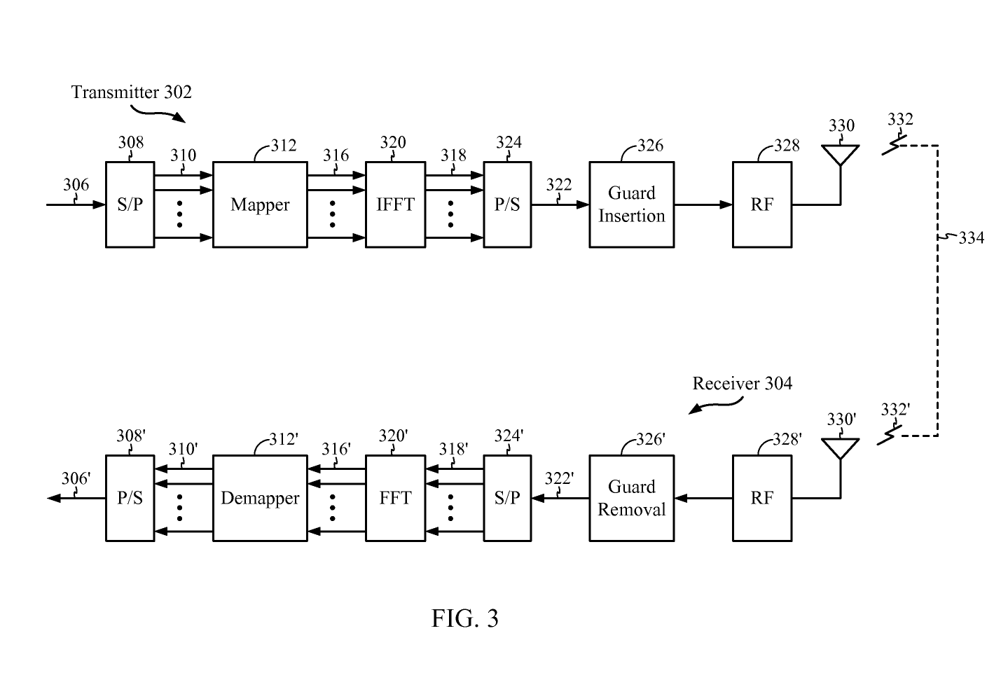

FIG. 3 illustrates an example of a transmitter 302 that may be used within a wireless communication system 100 that utilizes OFDM/OFDMA. Portions of the transmitter 302 may be implemented in the transmitter 210 of a wireless device 202. The transmitter 302 may be implemented in a base station 104 for transmitting data 306 to a user terminal 106 on a downlink 108. The transmitter 302 may also be implemented in a user terminal 106 for transmitting data 306 to a base station 104 on an uplink 110.

Data 306 to be transmitted is shown being provided as input to a serial-to-parallel (S/P) converter 308. The S/P converter 308 may split the transmission data into M parallel data streams 310.

The M parallel data streams 310 may then be provided as input to a mapper 312. The mapper 312 may map the M parallel data streams 310 onto M constellation points. The mapping may be done using some modulation constellation, such as binary phase-shift keying (BPSK), quadrature phase-shift keying (QPSK), 8 phase-shift keying (8PSK), quadrature amplitude modulation (QAM), etc. Thus, the mapper 312 may output M parallel symbol streams 316, each symbol stream 316 corresponding to one of the M orthogonal subcarriers of the inverse fast Fourier transform (IFFT) 320. These M parallel symbol streams 316 are represented in the frequency domain and may be converted into M parallel time domain sample streams 318 by an IFFT component 320.

A brief note about terminology will now be provided. M parallel modulations in the frequency domain are equal to M modulation symbols in the frequency domain, which are equal to M mapping and M-point IFFT in the frequency domain, which is equal to one (useful) OFDM symbol in the time domain, which is equal to M samples in the time domain. One OFDM symbol in the time domain, Nₛ, is equal to N_{cp}, (the number of guard samples per OFDM symbol)+M (the number of useful samples per OFDM symbol).

The M parallel time domain sample streams 318 may be converted into an OFDM/OFDMA symbol stream 322 by a parallel-to-serial (P/S) converter 324. A guard insertion component 326 may insert a guard interval between successive OFDM/OFDMA symbols in the OFDM/OFDMA symbol stream 322. The output of the guard insertion component 326 may then be upconverted to a desired transmit frequency band by a radio frequency (RF) front end 328. An antenna 330 may then transmit the resulting signal 332.

FIG. 3 also illustrates an example of a receiver 304 that may be used within a wireless device 202 that utilizes OFDM/OFDMA. Portions of the receiver 304 may be implemented in the receiver 212 of a wireless device 202. The receiver 304 may be implemented in a user terminal 106 for receiving data 306 from a base station 104 on a downlink 108. The receiver 304 may also be implemented in a base station 104 for receiving data 306 from a user terminal 106 on an uplink 110.

The transmitted signal 332 is shown traveling over a wireless channel 334. When a signal 332′ is received by an antenna 330′, the received signal 332′ may be downconverted to a baseband signal by an RF front end 328′. A guard removal component 326′ may then remove the guard interval that was inserted between OFDM/OFDMA symbols by the guard insertion component 326.

The output of the guard removal component 326′ may be provided to an S/P converter 324′. The S/P converter 324′ may divide the OFDM/OFDMA symbol stream 322′ into the M parallel time-domain symbol streams 318′, each of which corresponds to one of the M orthogonal subcarriers. A fast Fourier transform (FFT) component 320′ may convert the M parallel time-domain symbol streams 318′ into the frequency domain and output M parallel frequency-domain symbol streams 316′.

A demapper 312′ may perform the inverse of the symbol mapping operation that was performed by the mapper 312 thereby outputting M parallel data streams 310′. A P/S converter 308′ may combine the M parallel data streams 310′ into a single data stream 306′. Ideally, this data stream 306′ corresponds to the data 306 that was provided as input to the transmitter 302. Note that elements 308′, 310′, 312′, 316′, 320′, 318′ and 324′ may all be found in a baseband processor 340′.

### Dynamic Service Flow Schemes Based on the Available Battery Power

Certain embodiments of the present disclosure provide solutions that may extend useful lifetime of communications (“air time”) for a battery powered mobile device. By monitoring availability of battery power at the mobile device and adjusting one or more processing parameters (e.g., a clock rate or allowable data rate) based on service flows, air time may be extended by reducing power consumption, when possible, while still satisfying QoS requirements.

Techniques according to certain embodiments may utilize a step function in order to limit a maximal average data rate at the mobile device under different threshold values of the available battery power. As will be described in greater detail below, once the maximal average data rate is predictable, then a maximal millions of instructions per second (MIPS) consumption rate may also be predictable. As a result, a mobile device may be able to reduce processor clock rates, based on a predicted MIPS consumption rate, to reduce overall power consumption.

For certain embodiments, under certain conditions, MIPS consumption rate may also be reduced. For example, once a mobile device detects battery power is at or below a certain threshold value, then the device may be able to adjust the MIPS consumption rate as well as the processor clock rate of the mobile device. Therefore, the communication link between the mobile device and a base station may be maintained much longer (e.g., exponentially by a square factor) when compared with conventional techniques. Techniques proposed herein may be applied to all wireless communication protocols ranged from the 2G, 3G, and 4G, as well as from long range protocols to short range protocols.

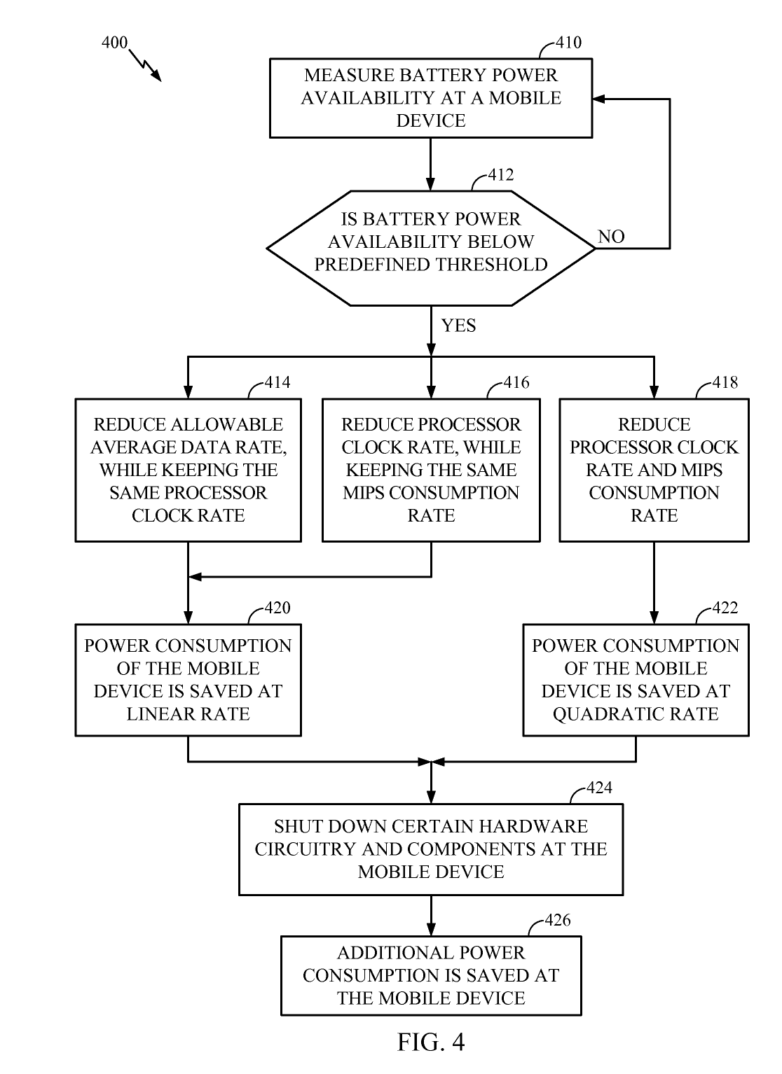

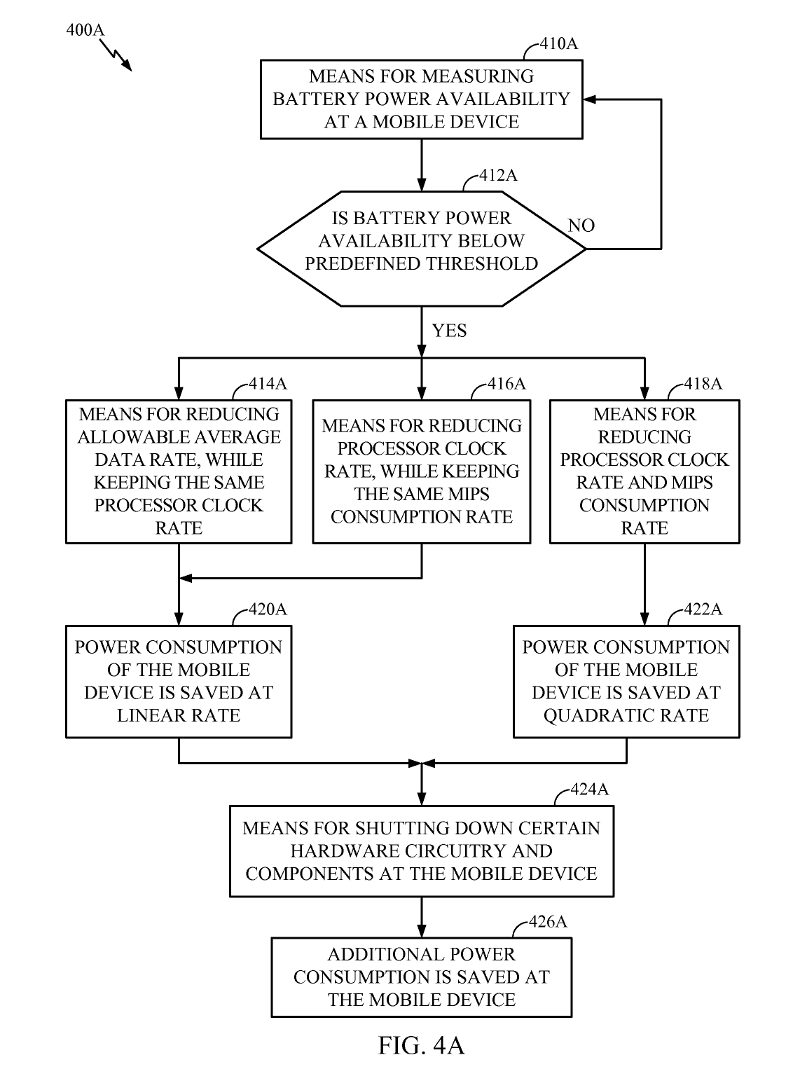

FIG. 4 shows example operations 400 for conserving power at a mobile device. The illustrated operations include operations for reducing allowable data rate and/or reducing processor clock rate (with or without reducing the device MIPS consumption rate).

At 410, the mobile device may measure its battery power availability. If the battery availability is below a predefined threshold value (as determined at 412), then the allowable average data rate may be reduced, at 414, while keeping the same processor clock rate. Therefore, the power consumption of the mobile device may be saved at a linear rate, at 420.

According to certain embodiments, when the available battery power is below the predefined threshold value, the average data rate may be significantly reduced (at 414). Such a significant reduction in data rate may be accompanied by a significant reduction in MIPS consumption rate. For such a scenario, communication latency may not be of great importance (e.g., maintaining a connection at all in such a low battery state may be sufficient).

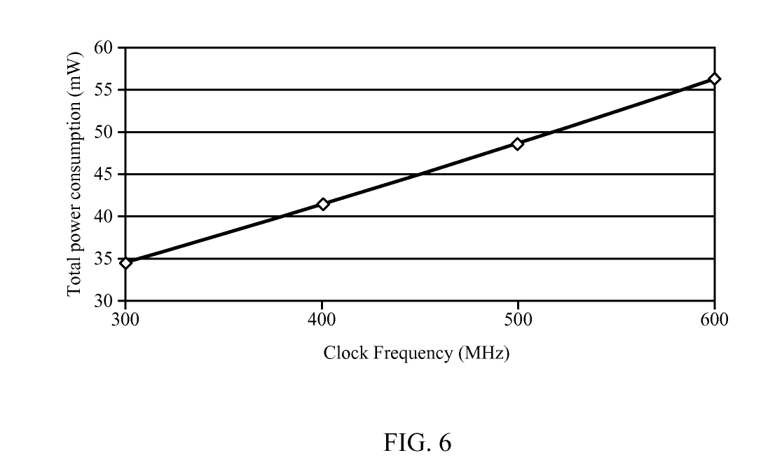

Therefore, for certain embodiments, the processor clock rate may be reduced, at 416, while the same MIPS consumption rate may be utilized. Consequently, at 420, the power consumption of the mobile device may be again saved at the linear rate. As shown in FIG. 6, lower processor clock rate of 300 MHz can reduce the power consumption by up to 50% compared to the case of higher processor clock rate of 600 MHz.

According to certain embodiments, once the maximal average data rate is predictable, the maximal MIPS consumption rate is also predictable. Therefore, for certain embodiments, at 418, the processor clock rate and MIPS consumption rate may both be reduced. In this scenario, power consumption of the mobile device may be saved at a quadratic rate, at 422.

According to certain embodiments, the mobile device may be configured to shut down certain hardware circuitry and components, at 424, in order to save additional power consumption. With such components powered down, additional power consumption may be saved, at 426.

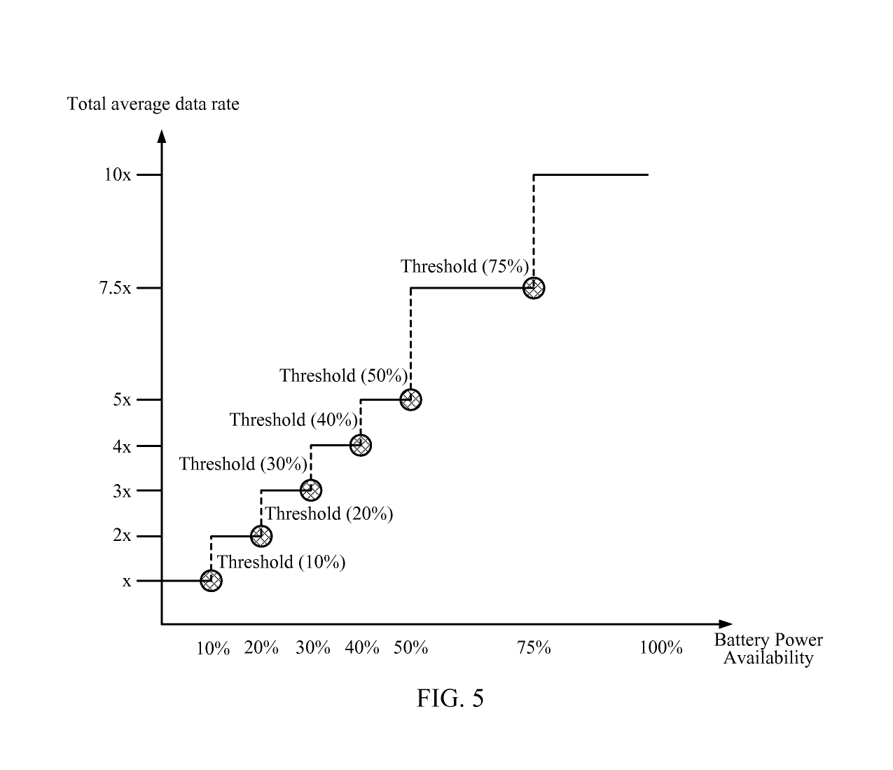

According to certain embodiments, total allowable average (uplink and downlink) data rate may be varied as a step function based upon the range of battery power availability at the mobile device (i.e., threshold values of battery power), as shown in FIG. 5. Different QoS categories may define maximal, minimal, and average data rate for every communication link in the system. The total data rate may be obtained as a sum of the traffic of all links belonging to uplink and downlink. When the data rate is applied according to the exemplary step function from FIG. 5, then the total average data rate of 5·x may be obtained, where x is a constant data rate value.

A total number of instructions I executed on a processor of the mobile device for a given time period T may be represented as:

I=V·T, (1)

where V is a speed of incoming instructions. A total power consumed by I instructions within the time period T may be represented as:

$${P}_{total} = {P}_{initial} + I \cdot \frac{{P}_{i}}{T} , \qquad ( 2 )$$

where Pᵢₙᵢₜᵢₐₗ is an initial power consumed by the processor of the mobile device when no instruction is executed, and Pᵢ is an average consumed power per a single instruction.

From equation (1) and equation (2) it follows that:

Pₜₒₜₐₗ=Pᵢₙᵢₜᵢₐₗ+V·Pᵢ. (3)

It can be observed from equation (3) that the speed of incoming instructions V may be proportional to the power consumption. Therefore, when the speed of incoming instructions is decreased (i.e., when the data rate is decreased), then the MIPS consumption rate may be automatically reduced according to equation (1), and the power consumption is saved at a linear rate as given by equation (3). It can be assumed that the processor clock rate may be constant. As illustrated in FIG. 5, the present disclosure proposes to gracefully reduce the data rate of the mobile device using the step function when the battery power is below the predetermined threshold value. As a result, the power consumption may be saved at the linear rate.

As illustrated in FIG. 5, for an exemplary case of a threshold activation point equal to 50% of the total battery power availability, if the battery availability is below 40% of the predefined threshold value, then the allowable average data rate may be reduced by 20%; if the battery availability is below 30% of the threshold value, then the allowable average data rate may be reduced by 40%; if the battery availability is below 20% of the threshold value, then the allowable average data rate may be reduced by 60%; if the battery availability is below 10% of the threshold value, then the allowable average data rate may be reduced by 80%. Thus, by performing this technique, air time of the mobile device may be extended by up to 2.5 times, while the mobile device may still provide some degree of data transmission and receiving functionality.

According to certain embodiments, if the mobile device does not drop any communication link after reducing the average data rate, then the mobile device may be configured to further reduce overall data rate by varying the allowable data rate for certain links. For example, the mobile device may reduce the data rate or postpone communications for some communication links with lower QoS or with lower priority, in an effort to reduce overall average data rate. Furthermore, for certain embodiments, a mobile user may be allowed to create new links for different application, but with the restriction that these new links may be at lower data rates.

In current wireless communications protocols, even when the QoS and data rate of each communication link is considered, there may still be an issue of determining priority among different links. The priority among communication links may be defined only through associated QoS values for each individual link. That is, priority levels of any two communication links may be compared according to their QoS values. If, for example, two communication links have the same QoS value, then they have the same priority.

There are several heuristic techniques that can be proposed to solve the issue of same priority of different communication links. For certain embodiments, the user may be prompted from the wireless network to reprioritize its communication links by utilizing other parameters rather than the QoS parameter. The reprioritization process may be performed either during an initial configuration of the mobile device or when the available battery power drops below certain predefined threshold value. For certain embodiments, the average uplink data rate of communication links with equal priority may be automatically reduced, and the system may inform the user regarding this particular change that is due to a lower battery scenario.

For certain embodiments, the mobile device may reconfigure the average data rate for chosen communication links through a layer 3 (L3) channel/link reconfiguration process between the mobile device and the serving base station. The mobile device may send messages to alert the user of the mobile device that some low priority communication links can be automatically dropped, or the communication of lower priority links can be postponed. In the latter case the user may be asked to decide whether these communication links should be dropped or the transmission and reception should be continued using a lower data rate. Furthermore, the latter solution may require a reconfiguration of uplink and downlink data rates for certain number of communication links.

FIG. 6 illustrates the power consumption as a function of the clock rate when processor at the mobile device consumes, illustratively, at a fixed MIPS rate. As shown, lowering a processor clock rate from 600 MHz to 300 MHz may result in a 50% reduction in power consumption. Therefore, under the fixed MIPS rate, the power consumption may be proportional to the processor clock rate, and may be expressed as:

Pₜₒₜₐₗ=Pᵢₙᵢₜᵢₐₗ+f_{CLK}P_{f}, (4)

where f_{CLK} is the processor clock frequency in units of MHz, and P_{f} is a consumed power per MHz. It can be observed from equation (4) that if the clock frequency is decreased, then the power consumption may be linearly decreased.

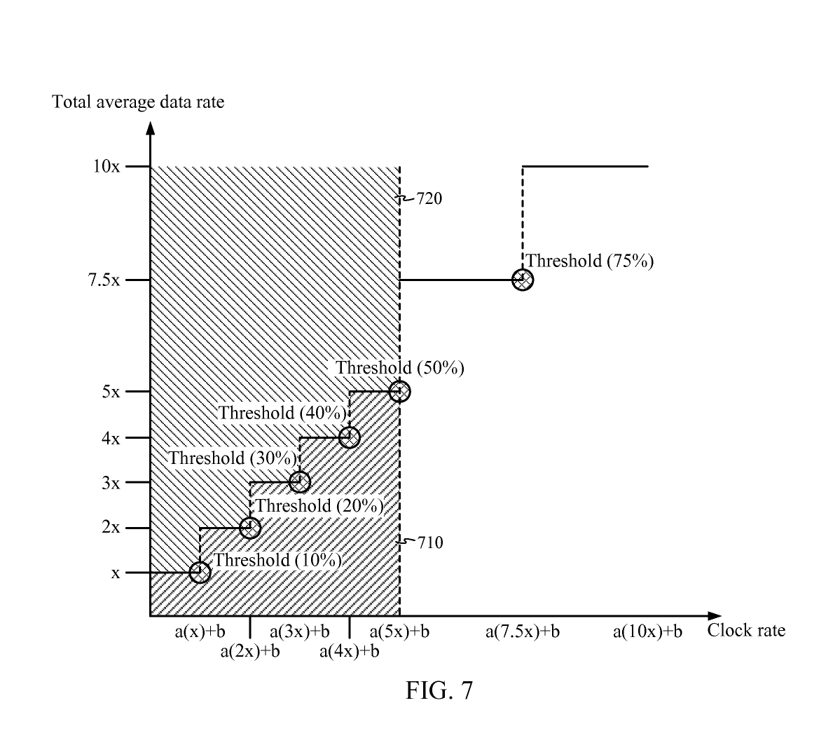

FIG. 7 illustrates the total average data rate at the mobile device as a function of its processor clock rate It is assumed an exemplary case when the threshold activation point is equal to 50% of the total available battery power. A parameter b in FIG. 7 represents an initial minimal clock rate that may be required to drive the processor of the mobile device. A parameter x in FIG. 7 is a constant number referring to the total average data rate from FIG. 5, where a(m·x) represents that the processor clock rate is a function of the total average data rate equal to m·x, where m=1, 2, 3, 4, 5, 7.5, and 10.

As previously described, once the total average data rate is predictable, the MIPS consumption rate is also predictable. This predictability may be used to allow the mobile device to reduce the processor clock rate to further reduce power consumption. As illustrated in FIG. 7, if both the processor clock rate and the data rate (i.e., the MIPS consumption rate) are simultaneously decreased once the available battery power falls below the threshold, then the power consumption may be reduced at a quadratic rate. An area 710 illustrated in FIG. 7 represents an average consumed power if both the processor clock rate and the total average data rate of the mobile devices are simultaneously decreased for the predetermined threshold value of available battery power of 50%. On the other hand, an area 720 represents a saved amount of power consumption at the mobile device if the proposed technique is applied.

By reducing allowable average data rates of a mobile device, processor clock rate and/or MIPS consumption rate, the overall time that connections may be maintained during times of low available battery power may be significantly increased. As a result, the overall mobile user experience may be significantly improved.

### Using QoS Information to Control Modem Hw for Low Battery Scenarios

Aspects of the present disclosure provide methods that may extend communication time for a battery powered mobile device while maintaining the quality of service (QoS) associated with each wireless link of the mobile device. Mobile devices may be sensitive to the availability of battery power. As such, when a battery dies, the functionality of the associated mobile device may be completely lost. According to aspects of the present disclosure, the power consumption of a mobile device may be gracefully decreased without significantly impacting active applications.

When the available battery power is below a certain threshold, the mobile device may lose functionality within a short period of time. To prevent loss of mobile device functionality, users may need to recharge the battery in a given period of time or readjust the use of mobile applications.

Aspects of the present disclosure provide a power saving feature that may attempt to satisfy QoS requirements even when a device is in a low power state. When the available battery power is below a certain threshold value, the power saving feature may be invoked to automatically extend the battery life of the mobile device. When the available battery power is above the threshold, the user may be allowed to decide whether the power saving feature should be activated to extend the battery life. According to certain aspects, a QoS based power saving feature may trigger the hardware to reconfigure a route to maintain current applications and satisfy QoS requirements, while still reducing battery consumption. Thus, mobile devices may extend battery life (and gain usable air time) using the described methods.

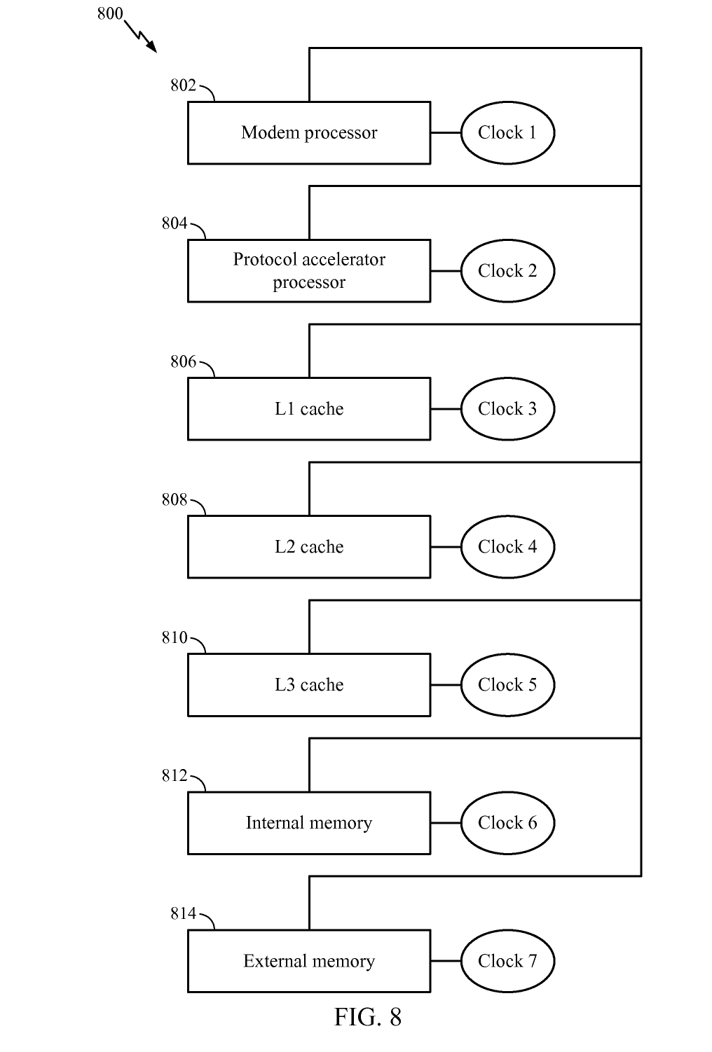

FIG. 8 illustrates an example mobile device modem hardware (HW) 800 according to aspects of the present disclosure. A mobile device may have modem HW dedicated to one or more wireless protocols, including, for example, 2G, 3G, 4G, and WiMAX. The modem HW may consist of a set of processors, memory, buses, and other HW components. The processors may be further divided into a general purpose computing modem processor 802 and protocol accelerator processor 804. The memory may include L1 cache 806, L2 cache 808, L3 cache 810, internal memory 812, and memory external to the processor 814. As illustrated in FIG. 8, one or more of the HW components may have an independent clock. The processors, memory, and buses may be running at the same or different speeds.

Cache configurations and clock rates may be controlled to improve the latency to result in increased processor MIPS results. Although lower clock rates and decreased use of cache may result in increased latency, it reduces battery power consumption and the decreased performance may still be acceptable for many applications. When available battery power is below a predetermined threshold, a power consumption factor may be more important than the processor MIPS performance. In order to maintain the same mobile functionality when the available battery power is below a threshold, the QoS information associated with each wireless link may be used to direct the modem HW to use a route with less power consumption while still maintaining QoS requirements.

QoS information may be given with some communication protocols. Some QoS criteria focus on the maximal, average, and minimal data to be guaranteed by the communication protocols, while other protocols may request for the minimal data rate, or average data rate. QoS parameters affect the data rate associated with each wireless link. The data rate may be translated to MIPS consumption.

According to aspects of the present disclosure, clock rates and latency control may be used to attempt to satisfy QoS requirements when a device is in a low power state. For example, the modem HW may be measured at different clock rates and latency to meet different data rates and MIPS consumption. A MIPS function F(f(clock rate), g(latency), etc.) is derived from several simple functions, f(clock rate), g(latency), etc. Each simple function with a single measured parameter may independently affect the MIPS value.

Thus, when a device is in a low power state, the modem HW may automatically determine a combination of hardware components to reduce power consumption while attempting to satisfy QoS requirements. The mobile device may switch to a different route to maintain communication links between physical layer HW and HW used by the protocol stack while maintaining QoS of the associated links. According to aspects of the present disclosure, software may be used to control the modem HW to decrease power consumption in when a device is in a low power state.

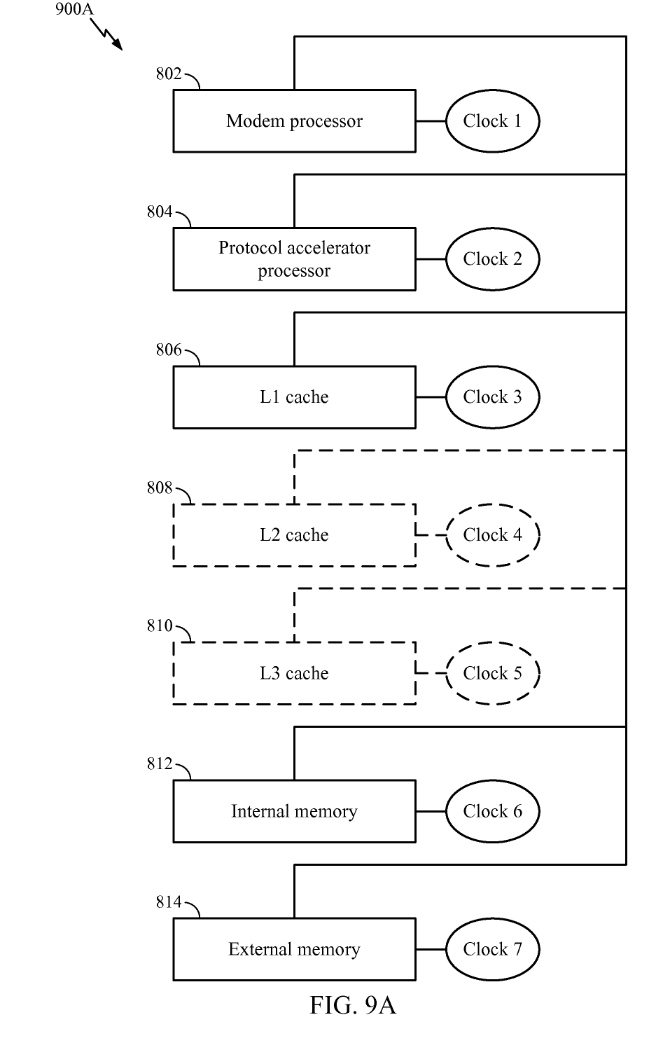

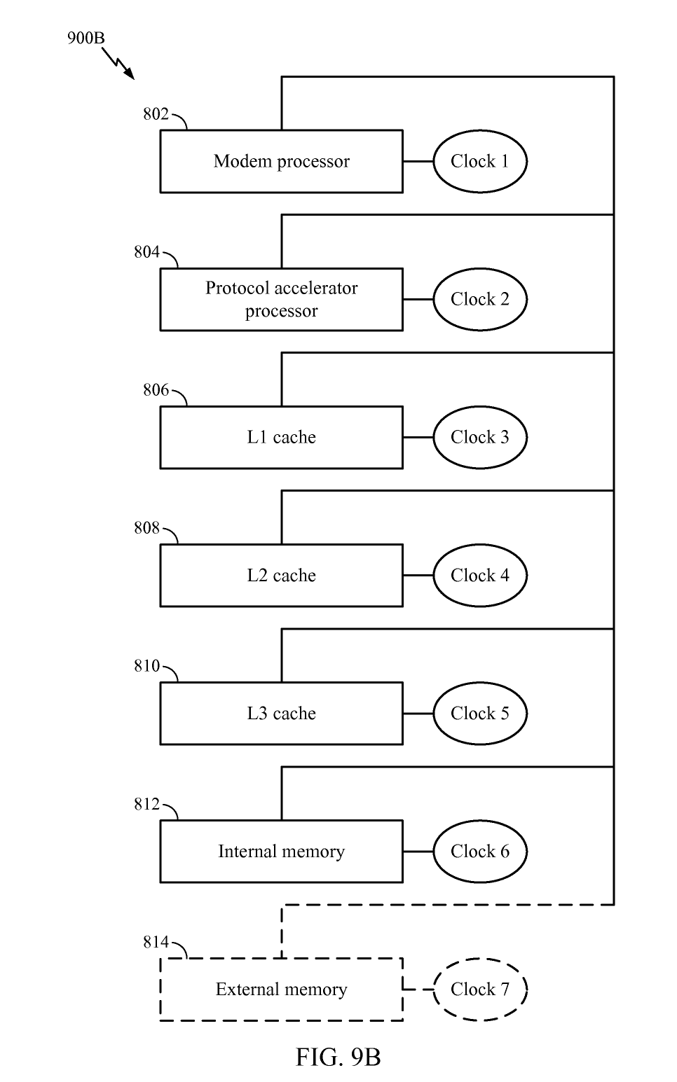

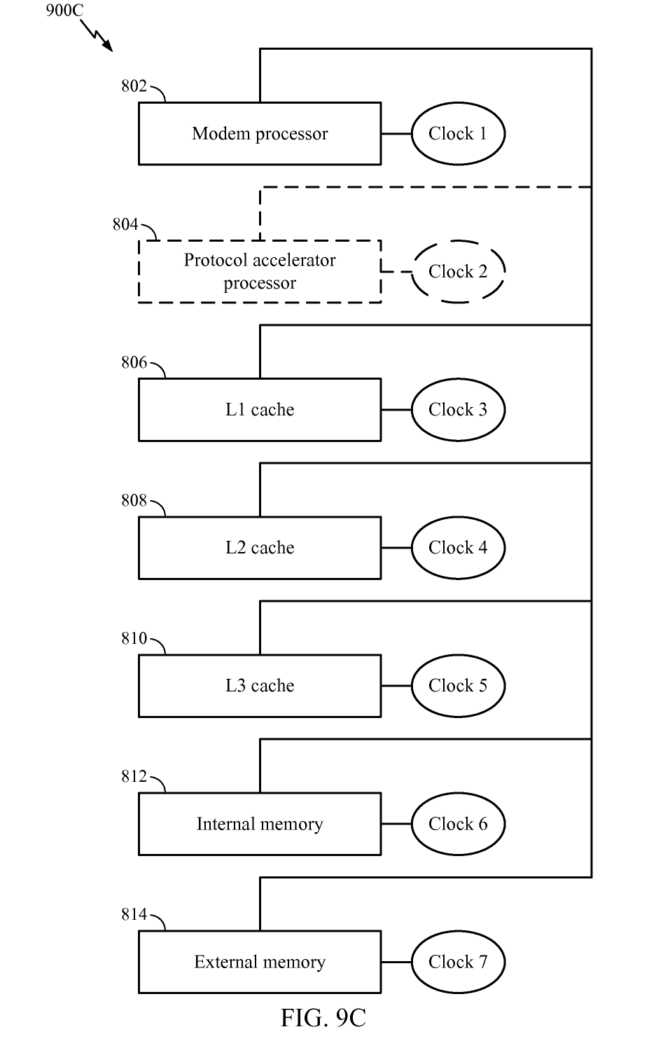

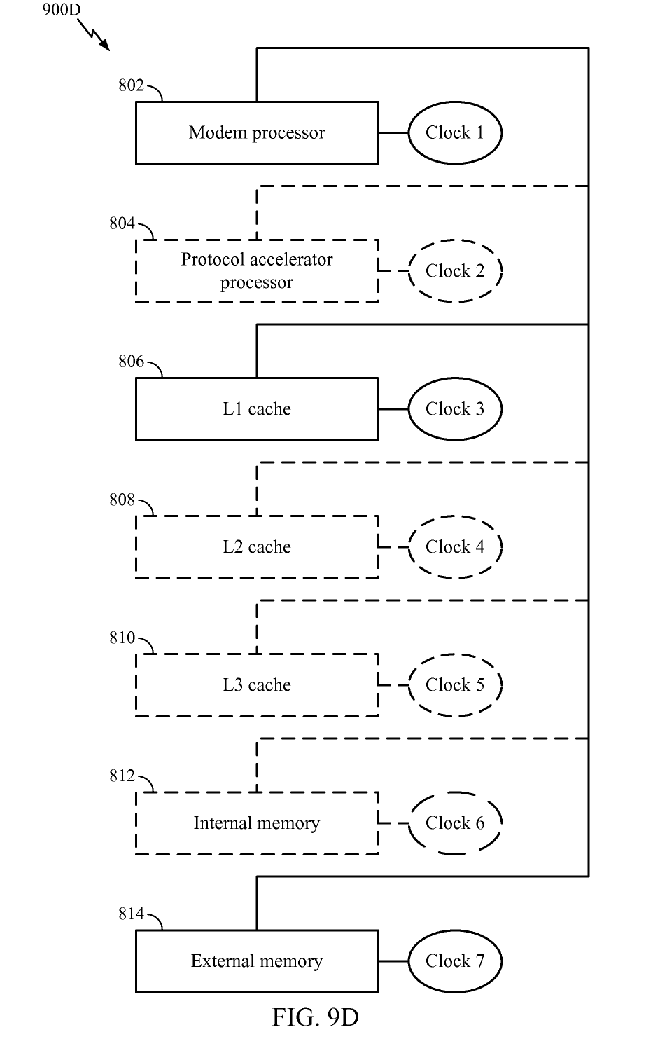

FIGS. 9A and 9B illustrate example embodiments of reducing power consumption while satisfying QoS requirements when a device is in a low power state by shutting down one or more memory components. FIG. 9A illustrates an embodiment 900A where the L2 cache 808 and L3 810 cache may be shut down when a device is in a low power state, for example when the available battery power is below a threshold. Alternatively, either one of the L2 cache 808 or L3 cache 810 may be shut down. According to certain aspects, the L2 cache 808 may be shut down when the available battery power is below a first predetermined threshold and the L3 cache 810 may be shut down when the available battery power is below a second predetermined threshold.

FIG. 9B illustrates an embodiment 900B of reducing power consumption and satisfying QoS requirements by shutting down a memory external to the processor 814 when a device is in a low power state. According to certain aspects, the memory external to the processor 814 may be shut down in combination with one or more components of the modem HW, including the protocol accelerator 804, L2 cache 808, L3 cache 810, and internal memory 812.

FIG. 9C illustrates an embodiment 900C of reducing power consumption and satisfying QoS requirements when a device is in a low power state by shutting down the protocol accelerator processor 804. The protocol accelerator processor 804 may be shut down in combination with one or more components of the modem HW. When the accelerator processor 804 is shut down, the modem processor 802 may process data. Although the modem processor 802 may take more time to process data as compared to the accelerator processor 804, shutting down the accelerator processor reduces the power consumption and may still be acceptable for many applications.

FIG. 9D illustrates an embodiment 900D of reducing power consumption and satisfying QoS requirements when a device is in a low power state by shutting down various components of the modem HW. According to certain aspects, the protocol accelerator processor 804, L2 cache 808, L3 cache 810, and internal memory 812 may be shut down. As a result, it may take more time for non-cached data to reach the modem processor 802 from the memory external to the processor 814, resulting in decreased MIPS. However, this may reduce battery power consumption and the decreased performance may still be acceptable for many applications. Because QoS features tolerate fluctuations in data rate, the functionality of wireless applications may be maintained as long as the data rate meets the given QoS requirements for a given link

Aspects of the present disclosure may reduce power consumption when a device is in a low power state by decreasing the clock rates used by one or more components of the modem HW. Although reducing one or more clock rates may result in decreased MIPS and increased latency, it reduces the battery power consumption may maintain QoS requirements for given links.

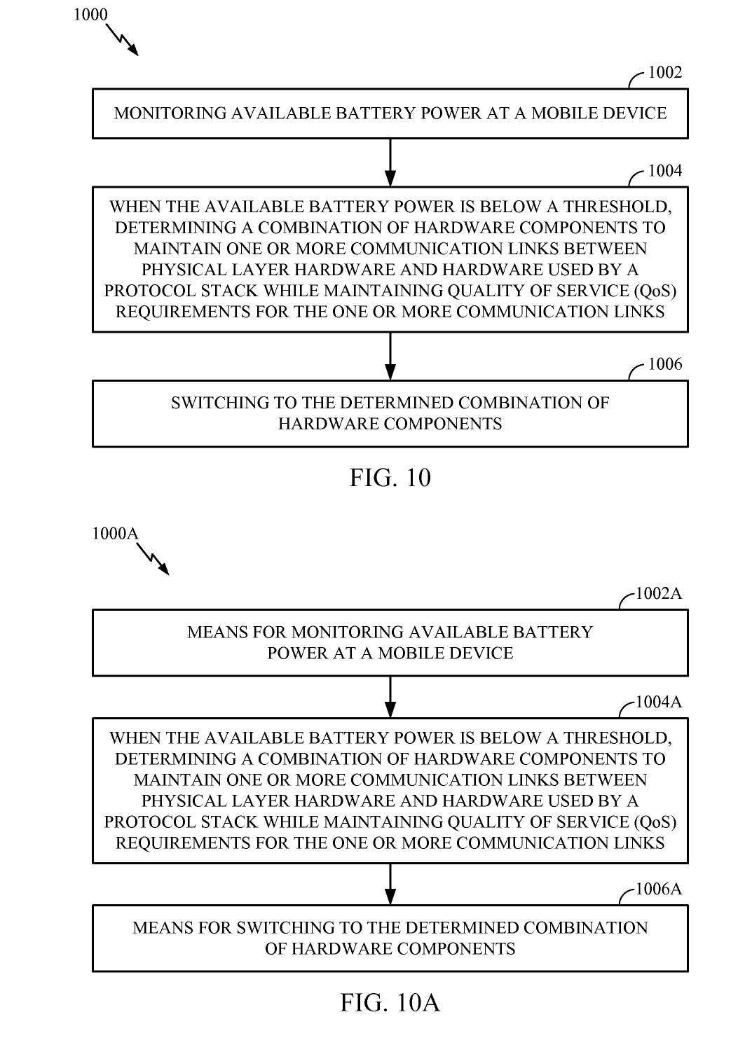

FIG. 10 illustrates example operations 1000 for reducing power consumption while meeting the minimal requirements of the QoS associated with each link when a mobile device is in a low power state, in accordance with aspects of the present disclosure. At 1002, a mobile device may monitor available battery power. When the available battery power is below a threshold, at 1004, the mobile device may determine a combination of hardware components to maintain one or more communication links between physical layer hardware and hardware used by a protocol stack while maintaining quality of service (QoS) requirements for the one or more communication links. At 1006, the mobile device may switch to the determined combination of hardware components.

The various operations of methods described above may be performed by various hardware and/or software component(s) and/or module(s) corresponding to means-plus-function blocks illustrated in the Figures. For example, blocks 410-426 illustrated in FIGS. 4 and 1002-1006 illustrated in FIG. 10 correspond to means-plus-function blocks 410A-426A illustrated in FIGS. 4A and 1002A and 1006A in FIG. 10A. More generally, where there are methods illustrated in Figures having corresponding counterpart means-plus-function Figures, the operation blocks correspond to means-plus-function blocks with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for wireless communications, comprising:
monitoring available battery power at a mobile device;
when the available battery power is below a threshold, determining a combination of hardware components to maintain one or more communication links between physical layer hardware and hardware used by a protocol stack while maintaining quality of service (QoS) requirements for the one or more communication links; and
switching to the determined combination of hardware components.

2. The method of claim 1, further comprising shutting down a memory of the mobile device when the battery power is below a threshold.

3. The method of claim 2, wherein shutting down a memory comprises shutting down at least one of a L2 and L3 cache of the mobile device.

4. The method of claim 2, wherein shutting down a memory comprises shutting down a memory external to a processor of the mobile device.

5. The method of claim 1, further comprising shutting down a protocol accelerator of the mobile device when the available battery power is below the threshold.

6. An apparatus for wireless communications, comprising:
means for monitoring available battery power at a mobile device;
when the available battery power is below a threshold, means for determining a combination of hardware components to maintain one or more communication links between physical layer hardware and hardware used by a protocol stack while maintaining quality of service (QoS) requirements for the one or more communication links; and
means for switching to the determined combination of hardware components.

7. The apparatus of claim 6, further comprising means for shutting down a memory of the mobile device when the battery power is below a threshold.

8. The apparatus of claim 7, wherein the means for shutting down a memory comprises shutting down at least one of a L2 and L3 cache of the mobile device.

9. The apparatus of claim 7, wherein the means for shutting down a memory comprises shutting down a memory external to a processor of the mobile device.

10. The apparatus of claim 6, further comprising means for shutting down a protocol accelerator of the mobile device when the available battery power is below the threshold.

11. An apparatus for wireless communications, comprising:
at least one processor adapted to:
monitor available battery power at a mobile device;
when the available battery power is below a threshold, determine a combination of hardware components to maintain one or more communication links between physical layer hardware and hardware used by a protocol stack while maintaining quality of service (QoS) requirements for the one or more communication links; and
switch to the determined combination of hardware components; and
a memory coupled to the at least one processor

12. The apparatus of claim 11, further comprising at least one processor is adapted to shut down a memory of the mobile device when the battery power is below a threshold.

13. The apparatus of claim 12, wherein the at least one processor adapted to shut down a memory comprises shutting down at least one of a L2 and L3 cache of the mobile device.

14. The apparatus of claim 12, wherein the at least one processor adapted to shut down a memory comprises shutting down a memory external to a processor of the mobile device.

15. The apparatus of claim 11, further comprising at least one processor adapted to shut down a protocol accelerator of the mobile device when the available battery power is below the threshold.

16. A computer readable medium having a computer-program product comprising instructions stored thereon, the instructions executable by one or more processors for:
monitoring available battery power at a mobile device;
when the available battery power is below a threshold, determining a combination of hardware components to maintain one or more communication links between physical layer hardware and hardware used by a protocol stack while maintaining quality of service (QoS) requirements for the one or more communication links; and
switching to the determined combination of hardware components.

17. The computer-program product of claim 16, further comprising shutting down a memory of the mobile device when the battery power is below a threshold.

18. The computer-program product of claim 17, wherein shutting down a memory comprises shutting down at least one of a L2 and L3 cache of the mobile device.

19. The computer-program product of claim 17, wherein shutting down a memory comprises shutting down a memory external to a processor of the mobile device.

20. The computer-program product of claim 16, further comprising shutting down a protocol accelerator of the mobile device when the available battery power is below the threshold.
